(19) United States
(12) Patent Application Publication
(10) Pub. No.: US 2026/0269235 A1
(43) Pub. Date: Sep. 10, 2026

(54) POSITIVE ELECTRODE ACTIVE MATERIAL AND MANUFACTURING METHOD OF MAGNESIUM STORAGE BATTERY

(71) Applicant: TOHOKU UNIVERSITY, Sendai-shi, Miyagi (JP)

(72) Inventors: Tetsu ICHITSUBO, Sendai-shi (JP); Tomoya KAWAGUCHI, Sendai-shi (JP); Masaya YASUDA, Sendai-shi (JP)

(21) Appl. No.: 19/164,075

(22) PCT Filed: Feb. 6, 2024
(86) PCT No.: PCT/JP2024/003922

§ 371 Date: Sep. 10, 2025

(30) Foreign Application Priority Data
Mar. 14, 2023 (JP) 2023-039299
Mar. 15, 2023 (JP) 2023-041425

(51) Int. Cl. H01M 4/525; C01G 49/00; H01M 4/04; H01M 10/054

(52) U.S. Cl. CPC H01M 4/525; C01G 49/0072; H01M 4/0445; H01M 10/054; C01P 2002/50; C01P 2002/72; C01P 2002/77; C01P 2002/85; C01P 2006/40

(57) ABSTRACT

A positive electrode active material for a magnesium storage battery is made of a material containing magnesium (Mg), lithium (Li), one type or two or more types of metal elements (M), and oxygen (O), and having a rock salt structure represented by General Formula (1).

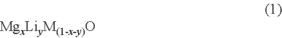

### CROSS-REFERENCE TO RELATED APPLICATIONS

This application is the U.S. National Stage entry of International Application No. PCT/JP2024/003922, filed on Feb. 6, 2024, which, in turn, claims priority to JP Patent Application No. 2023-039299, filed on Mar. 14, 2023, and JP Patent Application No. 2023-041425, filed on Mar. 15, 2023, all of which are hereby incorporated herein by reference in their entireties for all purposes.

### TECHNICAL FIELD

The present invention relates to a positive electrode active material for a magnesium storage battery, and a manufacturing method of a magnesium storage battery using the positive electrode active material.

### BACKGROUND ART

With the rapid spread of information related devices and communication devices such as mobile phones in recent years, a great emphasis has been placed on the development of batteries to be used as power sources of these devices. Also, in the automobile industry and the like, high-output and high-capacity batteries (e.g., lithium storage batteries) for electric vehicles or hybrid vehicles are under development.

On the other hand, there have been challenges to ensure a stable supply at low cost of lithium used as a raw material for lithium storage batteries, since lithium is not necessarily abundant as a resource, and its production areas are unevenly distributed. For this reason, a magnesium storage battery using magnesium, which is an abundant resource with evenly distributed production areas, instead of lithium is drawing attention.
Patent Document 1 discloses a positive electrode active material for a magnesium ion battery. The positive electrode active material contains an olivine-type magnesium silicate compound.
Patent Document 2 discloses a positive electrode active material for a magnesium ion battery. The positive electrode active material contains a rhodizonic acid-based compound and a perylene-based compound.

### CITATION LIST

### Patent Documents

Patent Document 1: JP 2017-208210 A

Patent Document 2: JP 2020-027702 A

### SUMMARY OF INVENTION

### Technical Problem

However, the positive electrode active material for a magnesium ion battery disclosed in Patent Document 1 has few vacancies contributing to insertion/extraction of magnesium ions, and has a problem of low charge/discharge characteristics when used in the magnesium storage battery.

On the other hand, the positive electrode active material for a magnesium ion battery disclosed in Patent Document 2 is an organic compound having a complicated structure, such as a rhodizonic acid-based compound or a perylene-based compound, and has problems of low productivity and high cost.

The present invention has been made in view of such a technical background, and an object of the present invention is to provide a positive electrode active material for a magnesium storage battery. The positive electrode active material enables efficient insertion/extraction of magnesium ions and can achieve high charge/discharge characteristics when the positive electrode active material is used in a magnesium storage battery.

### Solution to Problem

Regarding a metal oxide material having a disordered rock salt (DRX) structure as a positive electrode active material for a magnesium storage battery, in which reversible and effective insertion/extraction of Mg ions has been difficult by a known method, the present inventors have incorporated Li into a composition of a metal oxide having the DRX structure in advance, and preliminary charging has been conducted prior to use as a battery by actual charging and discharging, and Li is extracted toward an electrolyte, thereby introducing a vacancy into the DRX structure. The present inventors have newly found that the vacancy thus created enables repeated insertion/extraction of Mg ions even in the DRX structure.

The present invention has been made based on the newly found knowledge described above, and in order to solve the problems mentioned above, the present invention provides a positive electrode active material and a manufacturing method of a magnesium storage battery, which have the following requirements.
(1) A positive electrode active material according to aspect 1 of the present invention is a positive electrode active material for a magnesium storage battery, characterized in that the positive electrode active material is made of a material containing magnesium (Mg), lithium (Li), one or more metal elements (M), and oxygen (O), and having a rock salt structure represented by General Formula (1) set forth below:

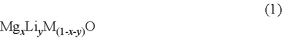

In General Formula (1), x and y satisfy x>0, y>0, and x+y<1.
(2) Aspect 2 of the present invention is the positive electrode active material according to aspect 1, characterized in that, in General Formula (1), y≥0.198 is satisfied.
(3) Aspect 3 of the present invention is the positive electrode active material according to aspect 1 or 2, characterized in that, in General Formula (1), M includes any one or two or more elements selected from the group consisting of Ti, V, Cr, Mn, Fe, Co, Ni, Cu, Zr, Nb, Mo, Ru, Rh, Pd, W, and Ir.
(4) Aspect 4 of the present invention is the positive electrode active material according to aspect 3, characterized in that, in General Formula (1), M further includes any one or two or more elements selected from the group consisting of Zn, Al, Si, Ga, Ge, Y, In, Sn, and Pb.
(5) Aspect 5 of the present invention is the positive electrode active material according to any one of aspects 1 to 4, characterized in that, in General Formula (1), M has an average valence of greater than 2.0, which is a composition ratio-weighted average of valences.
(6) Aspect 6 of the present invention is the positive electrode active material according to any one of aspects 1 to 5, characterized in that, in General Formula (1), x and y satisfy a relationship of General Formula (2) set forth below:

$$0.119 \leq 4 {( x + y )}^{2} y ( 1 - y ) ( 1 - y + {y}^{2} ) . \qquad ( 2 )$$

(7) Aspect 7 of the present invention is the positive electrode active material according to any one of aspects 1 to 6, characterized in that, in General Formula (1), M includes each of the elements: Cr, Mn, Fe, Zn, and Mo.
(8) A method of manufacturing a magnesium storage battery of aspect 8 of the present invention is a method of manufacturing a magnesium storage battery including: the positive electrode active material described in any one of aspects 1 to 7; an electrolyte; and a negative electrode active material, the method being characterized by including preliminary charging in which a voltage is applied across the positive electrode active material and the negative electrode active material, thereby diffusing lithium contained in the positive electrode active material into the electrolyte to create a vacancy in the positive electrode active material, the vacancy allowing insertion/extraction of magnesium ions.

### Advantageous Effects of Invention

According to the aspects of the present invention, there is provided a positive electrode active material for a magnesium storage battery that enables an efficient insertion/extraction of magnesium ions and can achieve high charge/discharge characteristics when used in a magnesium storage battery, and a method of manufacturing a magnesium storage battery having high charge/discharge characteristics.

### BRIEF DESCRIPTION OF DRAWINGS

FIG. 1 A schematic diagram illustrating a state of extraction of Li in a lattice in preliminary charging of a positive electrode active material of one embodiment.

FIG. 2 A ternary diagram showing a composition of Li, Mg, and M (total amount of metal elements) which is the composition of the positive electrode active material.

FIG. 3 A schematic diagram illustrating a state of Mg insertion/extraction during charging and discharging of the positive electrode active material.

FIG. 4 An XRD profile and a scanning transmission electron microscope image of a positive electrode active material in the as-synthesized state of Example 1 of the present invention.

FIG. 5 An image showing a result of EDS analysis by a scanning transmission electron microscope for each composition element.

FIG. 6 A schematic diagram illustrating a configuration of a magnesium storage battery for testing.

FIG. 7 A graph showing the results of a CV test in Example 1 of the present invention.

FIG. 8 A graph showing the results of a repeated charge/discharge test in Example 1 of the present invention.

FIG. 9 A graph showing a comparison between a charge capacity and a discharge capacity in Example 1 of the present invention.

FIG. 10 A graph showing changes in the composition ratio of Li and Mg in the positive electrode active material due to charging and discharging.

FIG. 11 An XRD profile of a positive electrode active material in the as-synthesized state of Example 2 of the present invention.

FIG. 12 A graph showing the results of a repeated charge/discharge test in Example 2 of the present invention.

FIG. 13 A graph showing a comparison between a charge capacity and a discharge capacity in Example 2 of the present invention.

### DESCRIPTION OF EMBODIMENTS

Hereinafter, embodiments of the present invention will be described in detail with reference to the drawings. Note that the drawings referenced in the following description illustrate, as a matter of convenience, characteristic portions in an enlarged scale in some cases in order to clarify the features, and the dimensional ratios and the like of each component are not always the same as in reality. In addition, materials, dimensions, and the like exemplified in the following description are merely examples, and the present invention is not necessarily limited thereto, and can be appropriately modified and implemented to the extent that the effect of the present invention is not changed.

### [Positive Electrode Active Material]

The positive electrode active material for a magnesium storage battery of the present embodiment is made of a material containing magnesium (Mg), lithium (Li), one type or two or more types of metal elements (M), and oxygen (O), and having a rock salt structure represented by General Formula (1) below.

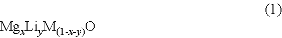

In General Formula (1), it is preferable that y≥0.198 is satisfied.

In General Formula (1), M preferably has an average valence of greater than 2.0, which is a composition ratio-weighted average of valences.

In General Formula (1), it is preferable that x and y satisfy a relationship represented by General Formula (2) below.

$$0.119 \leq 4 {( x + y )}^{2} y ( 1 - y ) ( 1 - y + {y}^{2} ) \qquad ( 2 )$$

It is more preferable that x and y satisfy a relationship of General Formula below.

$$0.12 < 4 {( x + y )}^{2} y ( 1 - y ) ( 1 - y + {y}^{2} )$$

In General Formula (1), one type or two or more types of the metal element (M) are only needed to be included, and for example, and the metal element (M) preferably includes at least one element of the following elements: Ti, V, Cr, Mn, Fe, Co, Ni, Cu, Zr, Nb, Mo, Ru, Rh, Pd, W, and Ir. Furthermore, along with the metal elements mentioned above, the metal element (M) more preferably includes any one element or two or more elements of the following elements: Zn, Al, Si, Ga, Ge, Y, In, Sn, and Pb.

In the present embodiment, as an example of the combination of the metal elements (M) in General Formula (1), each of the following elements: Cr, Mn, Fe, Zn, and Mo is preferably contained. That is, the metal element (M) preferably contains all of the following elements: Cr, Mn, Fe, Zn, and Mo.

More specifically, mention may be made of a material having a composition of Mg_{0.35}Li_{0.3}Cr_{0.1}Mn_{0.05}Fe_{0.05}Zn_{0.05}Mo_{0.1}O and a rock salt structure.

In the positive electrode active material of the present embodiment, i.e., in the metal oxide having the DRX structure containing Mg, when the material is used in a magnesium storage battery, the conditions of the material for reversible and smooth insertion/extraction of Mg ions are as follows.
(1) Extraction of Li that is contained in the initial composition and that for creating a vacancy is enabled (Li contained in the initial composition can be extracted to create a vacancy).
(2) An initial composition has one or two-vacancy path that allows percolation.
(3) Percolation through one or two-vacancy path is not lost even during charging and discharging.

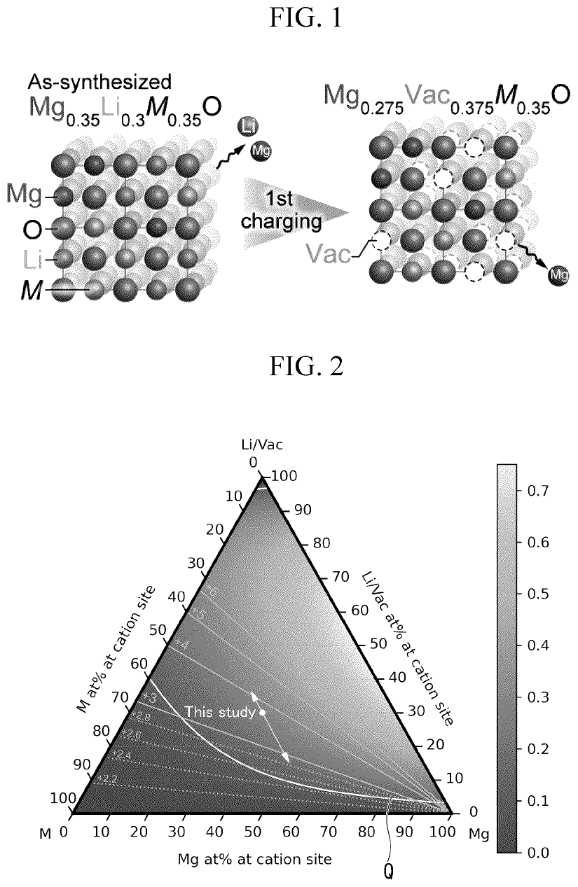

Regarding the condition (1) described above, as illustrated in FIG. 1, in preliminary charging (first-charging) described later, Li is extracted from the Li-containing positive electrode active material after synthesis, and is diffused into, for example, an electrolyte. That is, vacancies for insertion/extraction of Mg ions cannot be created in the subsequent charging and discharging unless Li contained in the initial composition of the positive electrode active material cannot be extracted in preliminary charging.

The ratio of Li contained in the initial composition of the positive electrode active material is required to be such that a critical percolation probability P_{c} is greater than or equal to 0.198 in the site process of a face-centered cubic lattice (fcc). Therefore, in General Formula (1), y≥0.198 is preferably satisfied. In the above-described example of the composition of the positive electrode active material of the present embodiment (Mg_{0.35}Li_{0.3}Cr_{0.1}Mn_{0.05}Fe_{0.05}Zn_{0.05}Mo_{0.1}O), the ratio of Li is 0.3, and the above-described condition (1) is satisfied.

Regarding the condition (2) described above, when the positive electrode active material having a DRX structure is used in a magnesium storage battery, Mg ions are needed to easily migrate inside the particles, but in a lattice-based probability theory, when a probability of presence of a migration path due to percolation is denoted by P, then a probability of absence of a migration path is 1-P. When the probability P of presence of a migration path is changed, clusters of various sizes capable of continuous migration are formed. Then, when the probability P of presence of a migration path is increased, a phase transition occurs from a non-percolation phase, which is a phase in which an infinitely large cluster is absent, to a percolation phase, which is a phase in which the cluster is present. The boundary at which the non-percolation phase changes to the percolation phase is the critical point, and the probability P_{c} at this time is the critical percolation probability. That is, when P>P_{c} is satisfied, an infinite cluster is formed, and the phase transition occurs to the percolation phase.

Then, when the probability P of presence of a migration path>the critical percolation probability P_{c} is satisfied, the migration paths are infinitely connected inside the particles, and Mg can easily diffuse using the migration paths.

For example, the probability of presence of a migration path defined as one-vacancy path Pₒₙₑ (P_{vac}, P_{M}, P_{Mg}) is represented by Equation (3) below.

$${P}_{one} = 4 {( 1 - {P}_{M} )}^{2} {P}_{vac} ( 1 - {P}_{vac} ) ( 1 - {P}_{vac} + {P}_{vac}^{2} ) \qquad ( 3 )$$

Herein, P_{vac}: a probability that a vacancy occupies a cation site, P_{M}: a probability that a metal element other than Mg occupies a cation site, and P_{Mg}: a probability that a Mg element occupies a cation site, then P_{vac}+P_{M}+P_{Mg}=1 (P is equivalent to the composition) is satisfied and Li is assumed to be completely extracted to create a vacancy.

Based on such a presence probability Pₒₙₑ, when the positive electrode active material has a composition satisfying Pₒₙₑ≥P_{c}=0.119 (critical percolation probability in the fcc bond process), Mg can easily diffuse inside the site using a migration path with low activation energy.

P_{vac} is Li composition ratio y, P_{Mg} is Mg composition ratio x, and P_{vac}+P_{M}+P_{Mg}=1 is satisfied, and therefore Equation (3) becomes Equation (4) below.

$${P}_{one} = 4 {( x + y )}^{2} y ( 1 - y ) ( 1 - y + {y}^{2} ) \qquad ( 4 )$$

Therefore, the positive electrode active material preferably has a composition satisfying Equation (2).

Based on this, if the composition amounts of Li, Mg, and M (total amount of metal elements), which are the composition of the positive electrode active material, are a combination in the range above the curve Q (the line on which the critical percolation probability=0.119) in the ternary diagram shown in FIG. 2, Mg easily diffuses inside the site using a path with low activation energy.

Examples of actual positive electrode active material compositions within the range above the curve Q in the ternary diagram shown in FIG. 2 are shown below.

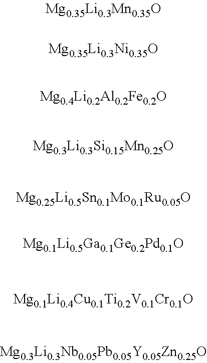

Note that, among the metal elements (M), elements whose valence is changeable during charging and discharging when used in a magnesium storage battery and which are considered to be electrochemically “active” are as follows:
Ti, V, Cr, Mn, Fe, Co, Ni, Cu, Zr, Nb, Mo, Ru, Rh, Pd, W, and Ir.

On the other hand, among the metal elements (M), elements whose valences are almost unchanged during charging and discharging and which are considered to be electrochemically “inactive” are as follows:
Zn, Al, Si, Ga, Ge, Y, In, Sn, and Pb.

Therefore, as can be seen from the above-described combination example, the metal element M constituting the positive electrode active material of the present embodiment needs to contain at least one or more elements considered to be electrochemically “active” described above. On the other hand, when an element considered to be electrochemically “inactive” is contained, the entire valence of the metal elements (M) constituting the positive electrode active material can be adjusted.

In addition, regarding the condition (3) described above, in order to ensure sufficient vacancies for insertion/extraction of Mg ions during charging and discharging, for example, metal elements (M) whose average valence that is a composition ratio-weight averaged valence is not 2.0 or less are used in the positive electrode active material of one example of the composition of the present embodiment

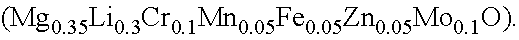

Specifically, in an example of the composition of the present embodiment (Mg_{0.35}Li_{0.3}Cr_{0.1}Mn_{0.05}Fe_{0.05}Zn_{0.05}Mo_{0.1}O), the above-described electrochemically active metal elements (Cr, Mn, Fe, Mo) and the above-described inactive metal element (Zn) are combined such that the minimum value of the average valence of the metal elements (M) is greater than +2.6. The adjustment of the valence by this is shown in Table 1. In an example of the composition of the present embodiment, the average valence of the metal elements (M), which is the composition ratio-weighted average of the valences, is a valence that can vary from +2.86 to +4.14.

TABLE 1

| Mₓ | Cr | Mn | Fe | Zn | Mo |
|---|---|---|---|---|---|
| x | 0.1 | 0.05 | 0.05 | 0.05 | 0.1 |
| Redox | +3/+4 | +2/+4 | +2/+3 | +2 | +4/+6 |

M: +2.86 (lowest)/+4.14 (highest)

As described above, according to the positive electrode active material of the present embodiment, a material having a DRX structure is used as a positive electrode active material of a magnesium storage battery, and charging and discharging enable repeated insertion/extraction of Mg ions. This contributes to the realization of a magnesium storage battery with excellent charge/discharge characteristics.

Note that, in the above-described embodiment, only Mg ions are exemplified as guest cations that are inserted into and extracted from the positive electrode active material after performing preliminary charging, however, there may be used a configuration where, together with Mg ions, Li ions are also as guest cations inserted into and extracted from the positive electrode active material.

### [Production Method of Positive Electrode Active Material]

When producing the positive electrode active material of the above-described embodiment, for example, the Pechini process (complex polymerization process) can be used.

As an example, a method of producing a positive electrode active material having a composition of Mg_{0.35}Li_{0.3}Cr_{0.1}Mn_{0.05}Fe_{0.05}Zn_{0.05}Mo_{0.1}O will be described below.

First, nitrates of metal elements (Mg, Cr, Mn, Fe, Zn, and Li) constituting the positive electrode active material, ammonium molybdate, and lithium nitrate are provided, and they are stirred together with citric acid, propylene glycol, and distilled water to form a metal-citrate complex, which is allowed to undergo ester polymerization to give a metal polymer gel. The stirring needs to be performed, for example, at 80° C. to 120° C. for about 4 to 5 hours.

Next, the metal polymer gel is dried at 200° C. for about 20 hours, and then heat-treated to produce a high-purity metal oxide. The heat treatment needs to be performed, for example, at 400° C. to 500° C. for about 1 to 3 hours.

The metal oxide thus obtained is pulverized into fine powder with, for example, a ball mill. In the ball mill, for example, a step of pulverizing at a rotation speed of 500 rpm for 5 minutes needs to be repeated about 40 times. Then, the fine powdery metal oxide is heat-treated again. In the heat treatment at this time, for example, heating needs to be performed at 600° C. for about 10 hours under an argon gas atmosphere containing 5% or less hydrogen gas. Thereafter, the metal oxide is pulverized into fine powder again with a ball mill.

Thereafter, the above-mentioned fine powder of the metal oxide and sucrose are mixed at a weight ratio of 8:2, distilled water is added thereto, and the mixture is mixed for about 10 minutes, followed by carbonization heat treatment. In the carbonization heat treatment, for example, heating needs to be performed at 600° C. for about 4 hours in an argon gas atmosphere containing 5% or less hydrogen gas. Thereafter, the metal oxide is homogeneously stirred for about 10 minutes, thereby producing a positive electrode active material (Mg_{0.35}Li_{0.3}Cr_{0.1}Mn_{0.05}Fe_{0.05}Zn_{0.05}Mo_{0.1}O) of an example of the composition of the present embodiment.

### [Manufacturing Method of Magnesium Storage Battery]

When a magnesium storage battery is manufactured by using the positive electrode active material of the above-described embodiment, for example, in a package (housing), there are formed: an electrolyte layer; a positive electrode active material layer containing the positive electrode active material of the above-described embodiment and a positive electrode current collector (an electrode) on one side of the electrolyte layer; and a negative electrode active material layer containing a negative electrode active material and a negative electrode current collector (electrode) on the other side of the electrolyte layer, with the electrolyte interposed therebetween, thereby affording a magnesium storage battery formed body (pre-first-charging).

For each of the positive electrode current collector and the negative electrode current collector, a conductive metal that can be used as a current collector of batteries can be used. For example, a metal material containing one or two or more elements selected from the group consisting of Cu, Ni, Al, V, Au, Pt, Mg, Fe, Ti, Co, Cr, Zn, Ge, and In can be exemplified. The shapes of the positive electrode current collector and the negative electrode current collector are not particularly limited, and can be various forms such as foil, mesh, or porous.

The positive electrode active material layer may further contain a conductive material and a binder in addition to the positive electrode active material of the above-described embodiment (e.g., Mg_{0.35}Li_{0.3}Cr_{0.1}Mn_{0.05}Fe_{0.05}Zn_{0.05}Mo_{0.1}O).

The electrolyte layer generally includes an electrolyte solution and a separator. As the electrolyte solution, a known electrolyte solution used in a magnesium storage battery can be used, and one example thereof, mention may be made of a solution of Mg(AlCl₂EtBu)₂ dissolved in tetrahydrofuran, and Mg(CB₁₁H₁₂)₂/tetraglyme. Examples of the separator include porous membranes such as a porous polypropylene (PP) membrane, a porous polyethylene (PE) membrane, and a porous PP/PE/PP laminated membrane.

The negative electrode active material is not particularly limited as long as it can absorb magnesium ions during charging and release magnesium ions during discharging, and any known material can be used. Examples thereof include magnesium metal, and carbon materials such as graphite and amorphous carbon.

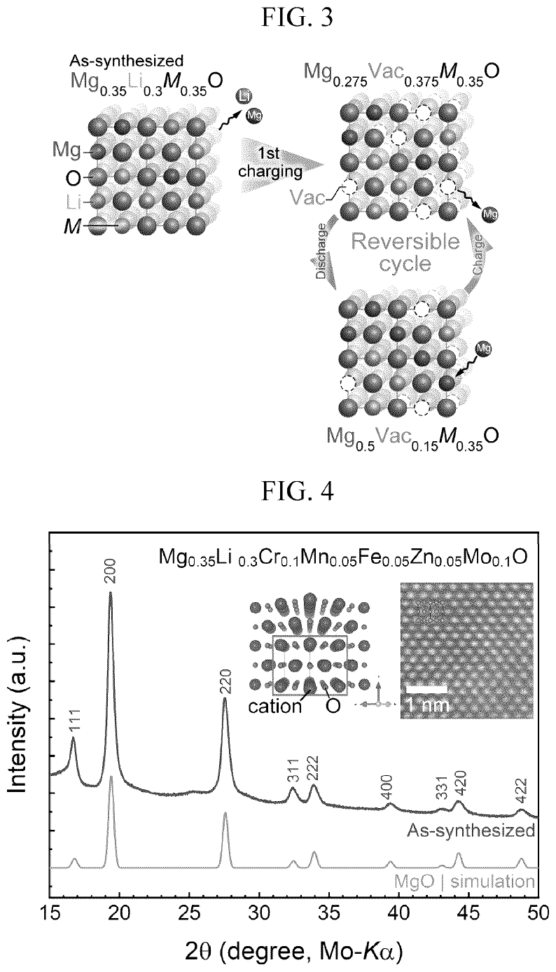

Using the formed body of the magnesium storage battery formed as described above, a voltage is applied across the positive electrode current collector and the negative electrode current collector (preliminary charging (first-charging)). As a result, in the positive electrode active material in the as-synthesized state, as illustrated in FIG. 3, lithium in the composition is extracted from the lattice of the DRX structure, and vacancies (Vac) are created in the lattice. The extracted lithium diffuses into the electrolyte layer, and the lithium will not be reinserted into the vacancies thereafter even when charging and discharging are performed. This is due to the very low concentration of diffused lithium in the electrolyte (lithium concentration in the electrolyte is about 0.3%).

As described above, preliminary charging is conducted and thereby the magnesium storage battery of the present embodiment is formed.

Thereafter, as illustrated in FIG. 3, the obtained magnesium storage battery is used to repeat charging and discharging and thereby magnesium is smoothly inserted into or extracted from the vacancies in the positive electrode active material of the magnesium storage battery, and electric power can be drawn.

Note that the liquid magnesium storage battery using an electrolyte solution is exemplified in the above embodiment, but the positive electrode active material of the present embodiment can be used in exactly the same manner as a constituent material of the positive electrode active material layer even in a solid-state magnesium storage battery in which a solid material is used as an electrolyte.

Although the embodiments of the present invention have been described above, these embodiments have been presented as examples, and are not intended to limit the scope of the present invention. These embodiments can be implemented in various other forms, and various omissions, substitutions, and modifications can be made without departing from the requirements of the present invention. These embodiments and modification examples thereof are included in the scope and requirements of the present invention and are as well as included in the invention described in the claims and the scope equivalent thereto.

### EXAMPLES

Hereinafter, verification examples of the present invention will be described, but the present invention is not limited to the configurations indicated in these verification examples.

### Verification Example 1 of Positive Electrode Active Material

A positive electrode active material (Mg_{0.35}Li_{0.3}Cr_{0.1}Mn_{0.05}Fe_{0.05}Zn_{0.05}Mo_{0.1}O) of Example 1 of the present invention was produced according to the above-described method for producing a positive electrode active material.

FIG. 4 shows an XRD profile of the positive electrode active material in the as-synthesized state of Example 1 of the present invention.

According to FIG. 4, the fundamental peaks with high intensity indicate a disordered rock salt structure.

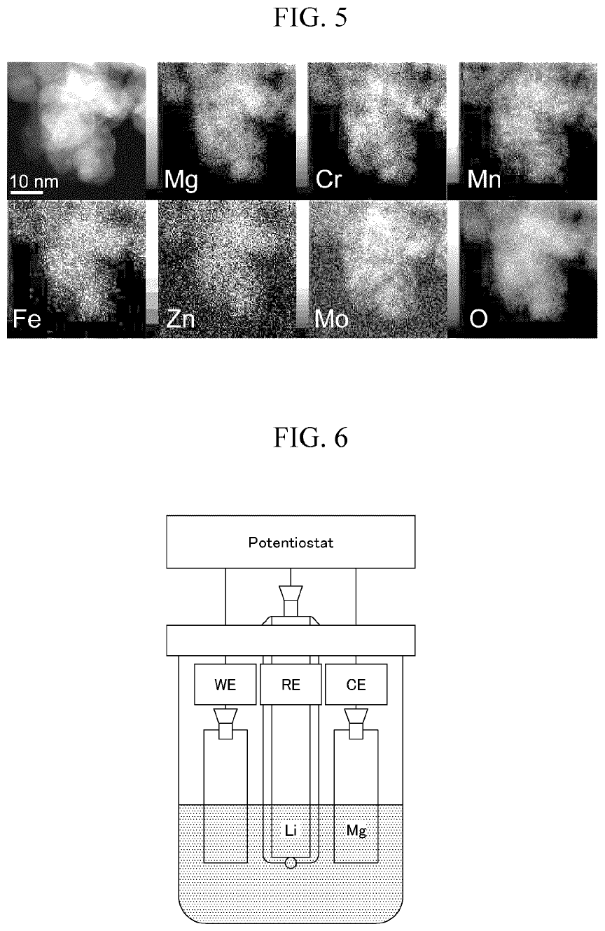

FIG. 5 shows the results of EDS analysis for each composition element by a scanning transmission electron microscope, which were obtained by using the positive electrode active material of Example 1 of the present invention.

FIG. 5 confirmed that the distribution of each metal element constituting the positive electrode active material of Example 1 of the present invention is homogeneous inside and among the particles at a nanometer level.

Table 2 shows the results of comparison between the composition of the positive electrode active material of Example 1 of the present invention at the time of raw material feeding before synthesis and the composition after synthesis. In Table 2, “exp.” indicates the composition of the final product as determined by quantitative analysis after synthesis, and “cf. target” indicates the composition of the target final product. For example, it is known that a part of Li is sublimated by heat treatment. Like this, a part of the elements of the raw material is lost in the synthesis process. The composition at the time of raw material feeding before the synthesis is substantially the same as the composition of the target final product, but strictly speaking, the composition at the time of raw material feeding before the synthesis is a composition obtained by adding the amounts of elements lost in the synthesis process to the composition of the target final product.

TABLE 2

| Composition | | Mg | Li | Cr | Mn | Fe | Zn | Mo | O |
|---|---|---|---|---|---|---|---|---|---|
| Mg_{0.35}Li_{0.3}Cr_{0.1}Mn_{0.05}Fe_{0.05}Zn_{0.05}Mo_{0.1}O | exp. | 0.367 | 0.276 | 0.109 | 0.052 | 0.049 | 0.041 | 0.105 | — |
| | cf. target | 0.35 | 0.3 | 0.1 | 0.05 | 0.05 | 0.05 | 0.1 | 1 |

According to the results shown in Table 2, the composition of the positive electrode active material at the time of raw material feeding before the synthesis and the composition after the synthesis were substantially the same, and it was confirmed that a positive electrode active material having a target composition can be accurately synthesized with almost no loss of elements by the above-described method for producing a positive electrode active material.

### Verification Example 1 of Magnesium Storage Battery

Next, a magnesium storage battery for testing as illustrated in FIG. 6 was assembled.

As the positive electrode active material, the positive electrode active material of Example 1 of the present invention (Mg_{0.35}Li_{0.3}Cr_{0.1}Mn_{0.05}Fe_{0.05}Zn_{0.05}Mo_{0.1}O) prepared according to the above-described method for producing a positive electrode active material was used.

As the negative electrode active material, a magnesium ribbon was used.

As the reference electrode, a piece of lithium foil immersed in a solution in which lithium bis(trifluoromethanesulfonyl)amide (TFSA) was dissolved at a concentration of 0.5 M in N,N-diethyl-N-methyl-N-(2-methoxyethyl)ammonium (DEME)-TFSA ionic liquid was used.

As the electrolyte solution, triglyme (G3)/Mg (TFSA)₂ was used.

The temperature during the testing was 90° C.

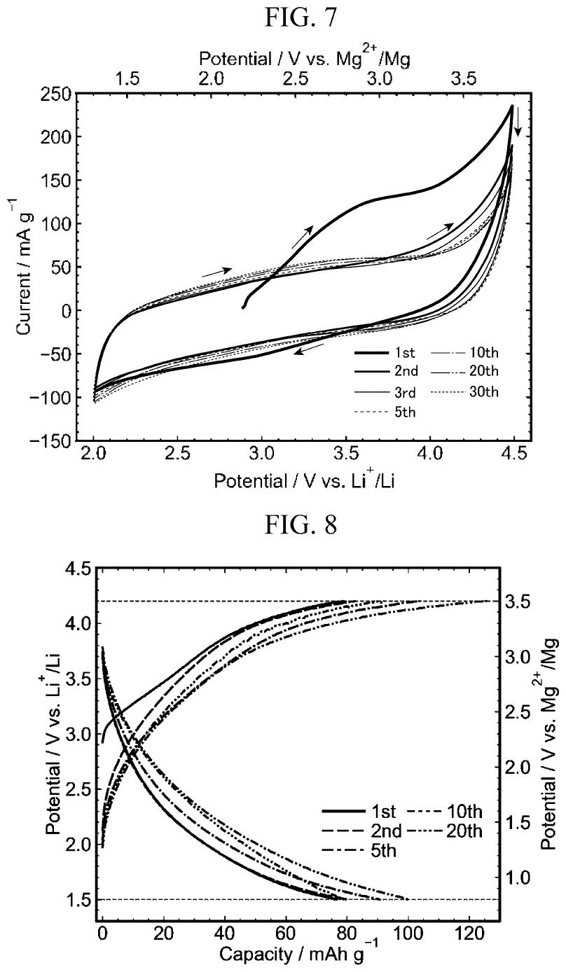

A CV test was performed using the magnesium storage battery for testing as illustrated in FIG. 6. The results are shown in the graph of FIG. 7.

According to the results shown in FIG. 7, a relatively large anodic current was observed in preliminary charging (first-charging). On the other hand, a cathodic current large enough to correspond to the anodic current in preliminary charging was not observed in the subsequent first discharge. In the second and subsequent charging and discharging, the values of the anodic current and the cathodic current were substantially symmetrical.

These results strongly suggest that the large anodic current generated in preliminary charging (first-charging) is due to the extraction of Li ions.

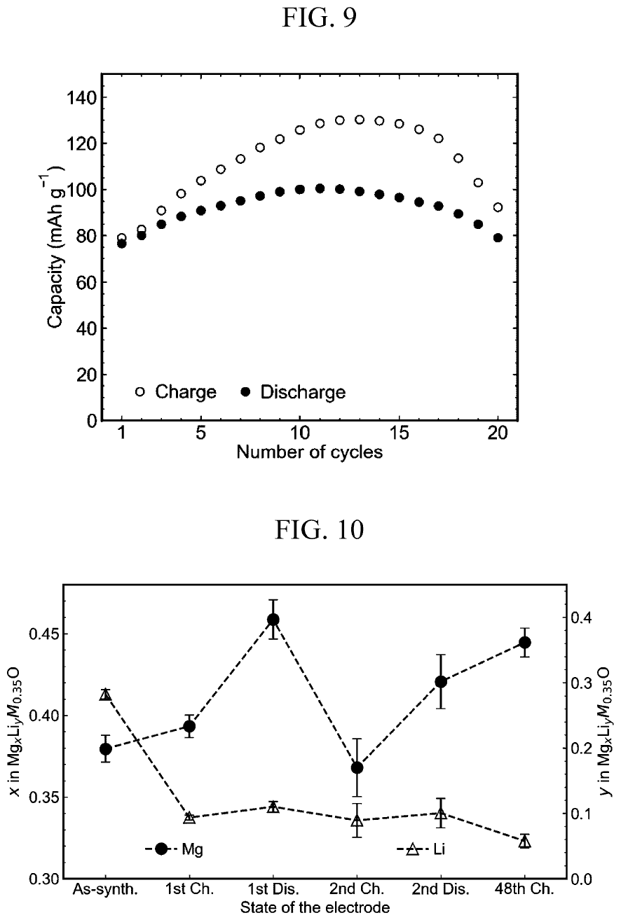

Next, a repeated charge/discharge test at a constant current was conducted using the magnesium storage battery for testing as illustrated in FIG. 6. Under the condition of 10.4 mAg⁻¹, the cutoff voltage was set to 1.5 to 4.2 V (vs. Li⁺/Li). The results are shown in the graph of FIG. 8. In addition, the comparison between the charge capacity and the discharge capacity is shown in the graph of FIG. 9.

The results shown in FIG. 8 indicate that no remarkable deterioration was observed after at least 20 cycles of charging and discharging, and it was confirmed that the battery using the positive electrode active material of Example 1 can be used stably as a secondary battery. In addition, according to the results shown in FIG. 9, the reason of the discharge capacity being smaller than the charge capacity is thought to be due to the influence of oxidative decomposition of the electrolyte solution and is not due to deterioration of the positive electrode active material.

The magnesium storage battery for testing as illustrated in FIG. 6 was used and the change in the composition ratio of Li and Mg in the positive electrode active material due to charging and discharging were examined using a high-frequency inductively coupled plasma (ICP) apparatus. The results are shown in the graph of FIG. 10.

The results shown in FIG. 10 indicates that when preliminary charging (1st-Ch) was performed, Li composition ratio was suddenly decreased from the as-synthesized state (As-synth) of the positive electrode active material, and did not return to the composition ratio in the as-synthesized state even in the subsequent charging and discharging, and Li composition ratio remained low. On the other hand, Mg composition ratio regularly increases and decreases in charging and discharging cycles. This confirmed that Li was extracted in preliminary charging, and thereafter, vacancies for Mg insertion/extraction were created, and that Li was not reinserted into the lattice of the positive electrode active material.

### Verification Example 2 of Positive Electrode Active Material

A positive electrode active material (Mg_{0.35}Li_{0.3}Mn_{0.35}O) of Example 2 of the present invention was produced according to the above-described method for producing a positive electrode active material.

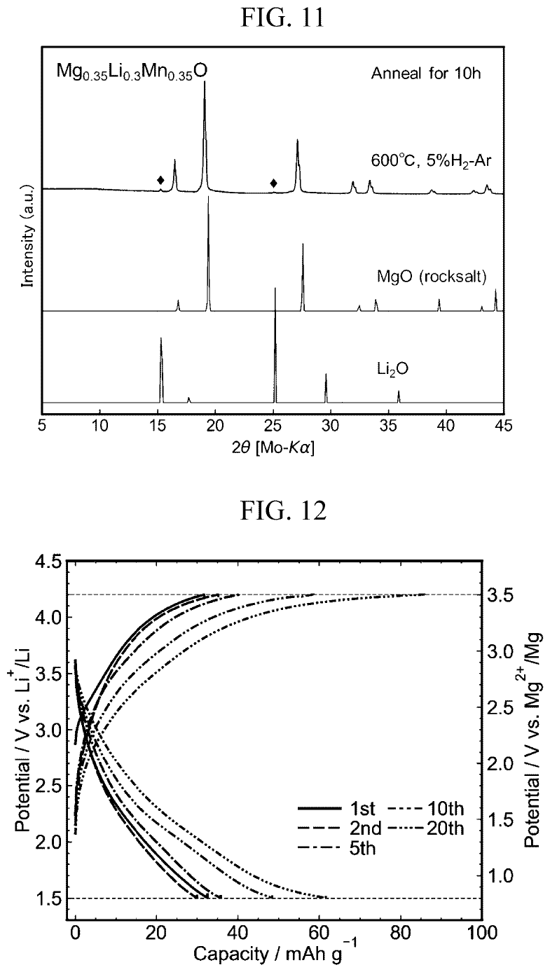

FIG. 11 shows the XRD profile of the positive electrode active material in the as-synthesized state of Example 2 of the present invention. Note that the XRD profiles of MgO and Li₂O are also shown as reference values.

According to FIG. 11, the strong fundamental peaks with high intensity of the positive electrode active material of Example 2 of the present invention indicate a disordered rock salt (DRX) structure. Note that the peaks indicated by “0” in the profile are attributed to inevitable impurities (e.g., Li₂CO₃).

### Verification Example 2 of Magnesium Storage Battery

Next, a magnesium storage battery for testing as illustrated in FIG. 6 was assembled.

As the positive electrode active material, the positive electrode active material (Mg_{0.35}Li_{0.3}Mn_{0.35}O) of Example 2 of the present invention prepared according to the above-described method for producing a positive electrode active material was used.

As the negative electrode active material, a magnesium ribbon was used.

As the reference electrode, a piece of lithium foil immersed in a solution in which lithium bis(trifluoromethanesulfonyl)amide (TFSA) was dissolved at a concentration of 0.5 M in N,N-diethyl-N-methyl-N-(2-methoxyethyl)ammonium (DEME)-TFSA ionic liquid was used. As the electrolyte solution, triglyme (G3)/Mg (TFSA)₂ was used.

The temperature during the testing was 90° C.

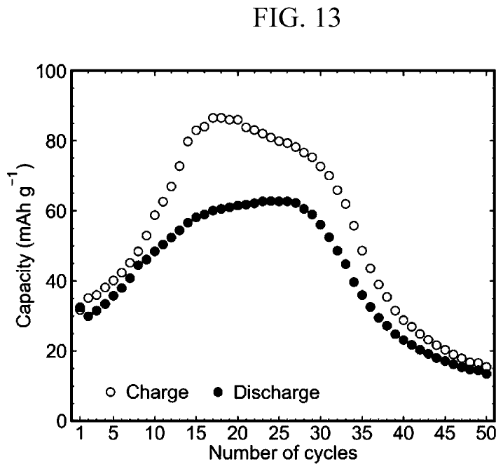

A repeated charge/discharge test at a constant current was performed using the magnesium storage battery for testing as illustrated in FIG. 6. Under the condition of 10.4 mAg⁻¹, the cutoff voltage was set to 1.5 to 4.2 V (vs. Li⁺/Li). The results are shown in the graph of FIG. 12. The graph in FIG. 13 shows a comparison between the charge capacity and the discharge capacity.

The results shown in FIG. 12 indicates that although the battery using the positive electrode active material of Example 2 of the present invention was slightly inferior to the battery using the positive electrode active material of Example 1 of the present invention, but remarkable deterioration was not observed after 20 cycles of charging and discharging, and it was confirmed that the battery using the positive electrode active material of Example 2 of the present invention can be stably used as a secondary battery. In addition, according to the results shown in FIG. 13, the reason of the discharge capacity being smaller than the charge capacity is thought to be due to the influence of oxidative decomposition of the electrolyte solution and is not due to deterioration of the positive electrode active material.

### INDUSTRIAL APPLICABILITY

According to the positive electrode active material of the present invention, it is possible to realize a magnesium storage battery in which efficient insertion/extraction of magnesium ions is enabled and high charge/discharge characteristics are realized. Therefore, the present invention has industrial applicability.

1. A positive electrode active material for a magnesium storage battery,
wherein the positive electrode active material is made of a material comprising magnesium (Mg), lithium (Li), one type or two or more types of metal elements (M), and oxygen (O), and having a rock salt structure represented by General Formula (1) set forth below:

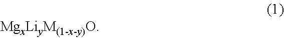

2. The positive electrode active material according to claim 1, wherein y≥0.198 is satisfied in General Formula (1).

3. The positive electrode active material according to claim 1, wherein M in General Formula (1) includes any one element or two or more elements selected from Ti, V, Cr, Mn, Fe, Co, Ni, Cu, Zr, Nb, Mo, Ru, Rh, Pd, W, and Ir.

4. The positive electrode active material according to claim 3, wherein M in General Formula (1) further includes any one element or two or more elements selected from Zn, Al, Si, Ga, Ge, Y, In, Sn, and Pb.

5. The positive electrode active material according to claim 1, wherein M in General Formula (1) has an average valence of greater than 2.0, which is a composition ratio-weighted average of valences.

6. The positive electrode active material according to claim 1, wherein x and y in General Formula (1) satisfy a relationship of General Formula (2) set forth below:
$$0.119 \leq 4 {( x + y )}^{2} y ( 1 - y ) ( 1 - y + {y}^{2} ) . \qquad ( 2 )$$

7. The positive electrode active material according to claim 1, wherein M in General Formula (1) includes each of elements: Cr, Mn, Fe, Zn, and Mo.

8. A method of manufacturing a magnesium storage battery comprising: the positive electrode active material described in claim 1; an electrolyte; and a negative electrode active material, the method comprising:
preliminary charging in which a voltage is applied across the positive electrode active material and the negative electrode active material, thereby diffusing lithium contained in the positive electrode active material into the electrolyte to create a vacancy in the positive electrode active material, the vacancy allowing insertion/extraction of a magnesium ion.
